(19) United States
(12) Patent Application Publication
(10) Pub. No.: US 2021/0234718 A1
(43) Pub. Date: Jul. 29, 2021

(54) NON-CONTACT COMMUNICATION MODULE FOR HOME APPLIANCE, AND CONTROL SYSTEM INCLUDING SAME

(71) Applicant: MIRO CO., LTD., Incheon (KR)

(72) Inventors: Dong Jin SEO, Incheon (KR); Yong Ju OH, Incheon (KR); Min Seok KIM, Incheon (KR)

(21) Appl. No.: 16/615,724

(22) PCT Filed: Apr. 23, 2019
(86) PCT No.: PCT/KR2019/004868

§ 371 Date: Nov. 21, 2019

(30) Foreign Application Priority Data
Dec. 10, 2018 (KR) 10-2018-0158492
Apr. 22, 2019 (KR) 10-2019-0046932

(51) Int. Cl. H04L 12/28; H04B 5/00; H02J 50/20

(52) U.S. Cl. CPC H04L 12/283; H04B 5/0037; H04L 2012/2841; H04L 12/282; H02J 50/20

(57) ABSTRACT

A non-contact communication module for a home appliance according to an embodiment may include: a first communicator that transmits and receives signals to and from a home appliance through local area wireless communication; a second communicator that transmits and receives signals to and from a server or a user terminal; and a controller that transmits signals received from the first communicator to the user terminal through the second communicator.

### TECHNICAL FIELD

An embodiment relates to a non-contact communication module for a home appliance, the non-contact communication module being able to perform transmission/reception with a home appliance in a non-contact type, and a control system including the non-contact communication module.

### BACKGROUND ART

Recently, a technology that enables transmission/reception of various items of information through network connection by mounting communication modules in home appliances that are disposed in a house or in specific spaces such as a refrigerator, a washing machine, an oven, and an air conditioner has been studied in order to improve convenience for users.

Communication modules are mounted and used in various kinds of home appliances with a fall in the prices, but they are not mounted in small home appliances due to an increase in price and difficulty in control of goods in stock.

In order to solve this problem, a communication module can be manufactured in a detachable memory type, but in this case, it is required to change the mold for a small device case, so there is a problem in that the cost is increased due to manufacturing of a mold and the manufacturing is complicated.

### DISCLOSURE

### Technical Problem

In order to solve these problems, an object of an embodiment is to provide a non-contact communication module for a home appliance for performing wireless communication without a change in structure of small home appliances, and a control system including the non-contact communication module.

### Technical Solution

A non-contact communication module for a home appliance according to an embodiment may include: a first communicator that transmits and receives signals to and from a home appliance through local area wireless communication; a second communicator that transmits and receives signals to and from a server or a user terminal; and a controller that transmits signals received from the first communicator to the user terminal through the second communicator.

The non-contact communication module may include a power receiver that receives power from an external device.

The external device may include a home appliance, and the home appliance may include a power transmitter therein that transmits power.

The non-contact communication module may include a chargeable battery that is charged with the power received from the power receiver.

The local area wireless communication may include NFC (near field communication).

When a distance from the home appliance is less than a first critical value, the controller may receive in real time and maintains power, and the first critical value may be a distance within which power can be received in real time.

When the distance from the home appliance is the first critical value or more and less than a second critical value, the controller may maintain power using the chargeable battery.

When the distance from the home appliance is the second critical value or more, power source may be cut off, and the second critical value may be a distance where a communication signal is disconnected.

Further, a home appliance control system according to an embodiment includes: a plurality of home appliances each including a communication module; a server transmitting and receiving signals to and from a server or a user terminal; and a non-contact communication module transmitting and receiving signals to and from the plurality of home appliances, and transmitting the transmitted and received signals to the server, in which the non-contact communication module may include: a first communicator transmitting and receiving signals to and from the communication module; a second communicator transmitting and receiving signals to and from the server; an information collector collecting signals received from the plurality of home appliances; and a controller analyzing signals collected by the information collector and controlling operation of the home appliances in response to signals provided from the user terminal.

When a request signal is received from the server or the user terminal, the controller may select controllable home appliances corresponding to the request signal and may control the selected home appliances.

The controller may determine whether the controllable home appliances are within an available communication distance, and selects the controllable home appliances.

The controller may determine whether the controllable home appliances are home appliances that are suitable for a request from a user, and may select the controllable home appliances.

The controller may provide a power supply signal to the selected home appliances.

The controller may operate one or more of the selected home appliances.

The non-contact communication module may include a display that displays a connection state and a control state of the home appliances.

The display may include a flash type LED or an LCD that shows the connection state and the control state of the home appliances using characters.

The non-contact communication module may include a sensor.

The non-contact communication module may further include a power receiver that receives power from the home appliances.

The non-contact communication module may include a chargeable battery that is charged with the power received from the power receiver.

### Advantageous Effects

There is an effect in the embodiment that there is provided a non-contact communication module that communicates with a home appliance in a non-contact type, thereby providing an effect that wireless communication is possible without a structural change of existing home appliances.

Further, there is an effect in the embodiment that it is possible to effectively use power by controlling the power source in accordance with a communication distance.

Further, there is an effect in the embodiment that it is possible to maintain a pleasant environment corresponding to a request from a user by controlling home appliances through wireless communication.

### DESCRIPTION OF DRAWINGS

FIG. 1 is a block diagram showing a home appliance control system according to a first embodiment.

FIG. 2 is a flowchart showing the operation of a non-contact communication module of the home appliance control system according to the first embodiment.

FIG. 3 is a block diagram showing a home appliance control system according to a second embodiment.

FIGS. 4 and 5 are flowcharts showing the operation of a non-contact communication module of the home appliance control system according to the second embodiment.

### BEST MODE

The present invention may be modified in various ways and implemented by various exemplary embodiments, so that specific exemplary embodiments are shown in the drawings and will be described in detail herein. However, it is to be understood that the present invention is not limited to the specific exemplary embodiments, but includes all modifications, equivalents, and substitutions included in the spirit and the scope of the present invention. Similar reference numerals are assigned to similar components in the following description of drawings.

Terms used in the specification, ‘first’, ‘second’, ‘A’, ‘B’, etc., may be used to describe various components, but the components are not to be construed as being limited to the terms. The terms are used only to distinguish one component from another component. For example, the ‘first’ component may be named the ‘second’ component, and vice versa, without departing from the scope of the present invention. The term ‘and/or’ includes a combination of a plurality of relevant items or any one of a plurality of relevant terms.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless defined otherwise, it is to be understood that all the terms used in the specification including technical and scientific terms has the same meaning as those that are understood by those who skilled in the art. It will be further understood that terms used herein should be interpreted as having a meaning that is consistent with their meaning in the context of this specification and the relevant art and will not be interpreted in an idealized or overly formal sense unless expressly so defined herein.

Hereinafter, exemplary embodiments of the present invention will be described in detail with reference to the accompanying drawings.

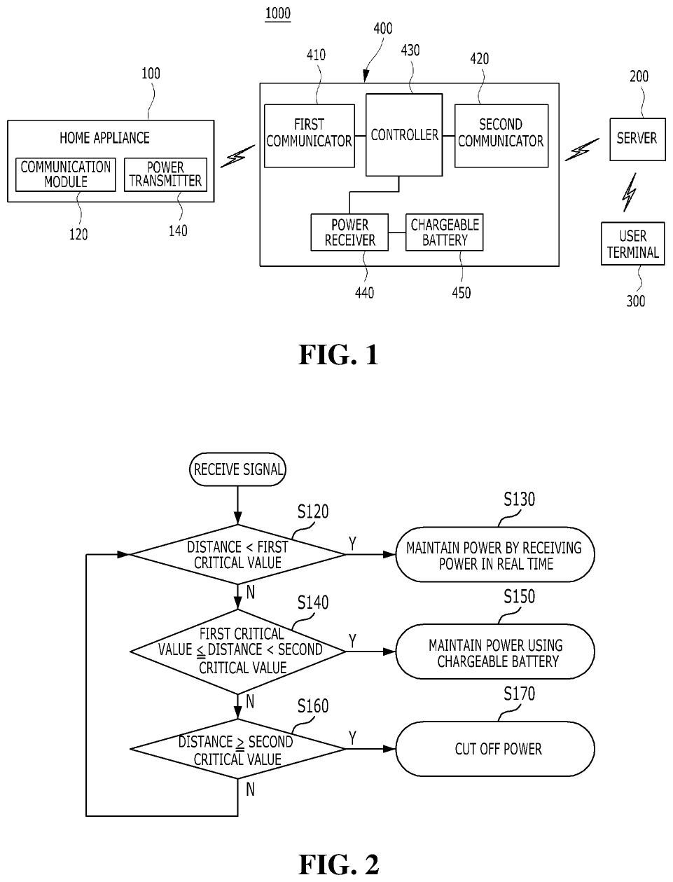

FIG. 1 is a block diagram showing a home appliance control system according to a first embodiment and FIG. 2 is a flowchart showing the operation of a non-contact communication module of the home appliance control system according to the first embodiment.

Referring to FIG. 1, a home appliance control system 1000 according to a first embodiment may include a non-contact communication module 400.

The non-contact communication module 400 can perform wireless communication between a home appliance 100 and a server 200 or the home appliance 100 and a user terminal 300. To this end, the non-contact communication module 400 may include a communicator. The communicator can use one of WiFi, Bluetooth, Zigbee, Z-wave, RF, NFC, and IR communication, or a combination of two or more thereof.

The non-contact communication module 400 may include a first communicator 410 and a second communicator 420. The first communicator 410 can perform wireless communication with the home appliance 100. The home appliance 100 herein may include a refrigerator, a cooker, a washing machine, a cleaner, a water purifier, a fan cooler/heater, a fan, a warmer, an air conditioner, a humidifier, an air purifier, etc., but is not limited thereto. The home appliance 100 may include a communication module 120 therein that can transmit/receive signals to/from the first communicator 410.

The first communicator 410 can transmit/receive signals to/from the home appliance 100 in a two-way type. The first communicator 410 may include local area wireless communication. The local area wireless communication may be NFC (Near Field Communication).

NFC is compatible for various devices and enables data synchronization by regulating the data size among all terminals including an NFC module. NFC can perform communication usually within a communication distance less than 10 cm. NFC has an effect that the possibility of leakage of private information is very small because the communication distance is short. The local area wireless communication may include Bluetooth, Zigbee, and IR communication other than NFC.

The second communicator 420 can perform wireless communication with the server 200. The server 200 herein may include a server that is operated by the manufacturer of the home appliance 100 or a company entrusted by the manufacturer, a server for services of the home appliance 100, a web server, etc. The server 200 can transmit the information of the home appliance 100 to the user terminal 300. The user terminal 300 may include a smartphone, an AI speaker, etc.

The second communicator 420 can transmit/receive signals to/from the server in a two-way type. The second communicator 420 may include a communication module such as WiFi, Bluetooth, Zigbee, but WiFi may be used in this embodiment.

Although the second communicator 420 transmits/receives signals to/from the server 200 in the above description, it may directly transmits/receives signals to/from the user terminal 300.

The non-contact communication module 400 may include a controller 430.

The controller 430 can transmit a signal received from the first communicator 410 to the server 200 through the second communicator 420 or can provide a control signal to the home appliance 100 in response to a signal received from the server 200 to control the home appliance 100. The signal may include a signal for control or a data signal.

For example, the controller 430 can transmit data provided from the home appliance 100 to the server, and when an instruction signal is received from a user, the controller 430 can provide a signal to the home appliance 100 to change the operation of the home appliance 100 in response to the instruction signal.

The non-contact communication module 400 may include a power receiver 440.

The power receiver 400 receives power from an external device in a wireless manner. The power receiver 440 can receive power in an electromagnetic induction manner that is used for a smartphone, a tablet, various wearable devices, an electric toothbrush, a razor, etc. The electromagnetic induction manner has an effect that the transmission distance is short, but the transmission efficiency is very high over 90%.

Since the power receiver 440 receives power in the electromagnetic induction manner, the power receiver 440 can effectively receive power even through a wireless charger for smartphones and a wireless charger for electric toothbrushes that are generally used. The power receiver 440 may be an induction coil.

In this embodiment, it is possible to receive wireless power from the home appliance 100. To this end, a power transmitter 140 may be disposed in the home appliance 100. When the non-contact communication module 400 is put on the home appliance 100 in the area where the power transmitter 140 is disposed, power can be transmitted to the non-contact communication module 400. The non-contact communication module 400 may be formed in a pebble shape herein.

Although power is transmitted/received in an electromagnetic induction manner for wireless charging in the above description, the present invention is not limited thereto and magnetic resonance type of charging may be used.

The non-contact communication module 400 may include a chargeable battery 450.

The chargeable battery 450 may include a battery pack that can store electricity therein and a PCB that controls charging/discharging of the chargeable battery 450. The chargeable battery 450 keeps power received from the power receiver 440 and it is possible to operate the non-contact communication module 400 using the power kept in the chargeable battery 450 when real-time power source for the non-contact communication module 400 is cut off.

Meanwhile, the controller 430 can cut off power, depending on the distance between the non-contact communication module 400 and the home appliance 100. For example, when the non-contact communication module 400 is positioned at a predetermined distance away from the home appliance 100 and transmission/reception of a signal is impossible, the power source for the non-contact communication module 400 can be controlled to be cut off.

According to NFC, in general, communication is performed when the distance from a home appliance is less than 10 cm and charging is performed when the distance from a home appliance is less than 1 cm, so it is possible to effectively control the power for the non-contact communication module 400 by using these communication distance and charge distance.

The controller 430 can use real-time power, use the power of the chargeable battery 450, or completely cut off power source, depending on the distance between the non-contact communication module 400 and the home appliance 100.

The operation of the controller 430 is described with reference to FIG. 2.

As shown in FIG. 2, the controller 430 can perform a process of checking whether the distance between the non-contact communication module 400 and the home appliance 100 is less than a first critical value when receiving a signal from the first communicator 410 (S120). The first critical value may be a distance within which power can be received in real time. The first critical value, for example, may be set as 1 cm.

The controller 430 can control power to be maintained by receiving real-time power when the distance between the non-contact communication module 400 and the home appliance 100 is less than the first critical value (S130). The chargeable battery 450 can be charged with power for this time.

When the distance between the non-contact communication module 400 and the home appliance 100 is not less than the first critical value, the controller 430 can perform a process of checking whether the distance between the non-contact communication module 400 and the home appliance 100 is the first critical value or more and less than a second critical value (S140). The second critical value may be a distance within which real-time power reception is impossible, but communication is possible. The second critical value, for example, may be set as 10 cm.

The controller 430 can maintain power using the chargeable battery 450 when the distance between the non-contact communication module 400 and the home appliance 100 is the first critical value or more and less than the second critical value (S150).

When the distance between the non-contact communication module 400 and the home appliance 100 is the first critical value or more and not less than the second critical value, the controller 430 can perform a process of checking whether the distance between the non-contact communication module 400 and the home appliance 100 is the second critical value or more (S160).

When the distance between the non-contact communication module 400 and the home appliance 100 is the second critical value or more, it means that communication is impossible, so the controller 430 can control power to be cut off (S170).

That is, when communication is impossible, the controller 430 can prevent unnecessary consumption of power.

When the distance between the non-contact communication module 400 and the home appliance 100 is not the second critical value or more, the controller 430 can return to the process of checking whether the distance between the non-contact communication module 400 and the home appliance 100 is less than the first critical value (S120).

Since the home appliance control system of the first embodiment includes the non-contact communication module 400 that is provided separately from the home appliance 100, there is an effect that wireless communication is possible without a structural change of existing home appliances.

Further, there is an effect in the embodiment that it is possible to effectively use power by controlling the power source in accordance with a communication distance.

Although the home appliance 100 is controlled through the non-contact communication module 400 in the above description, the home appliance 100 may be controlled through the server 200.

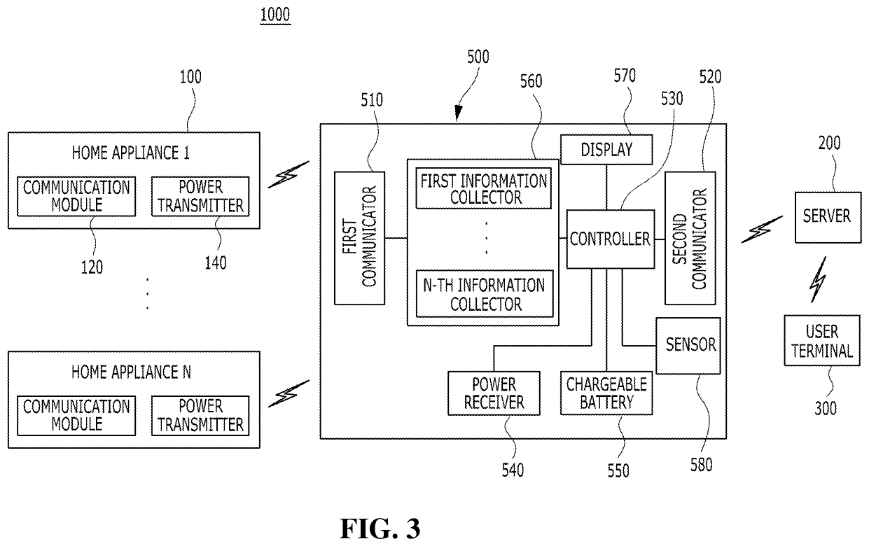

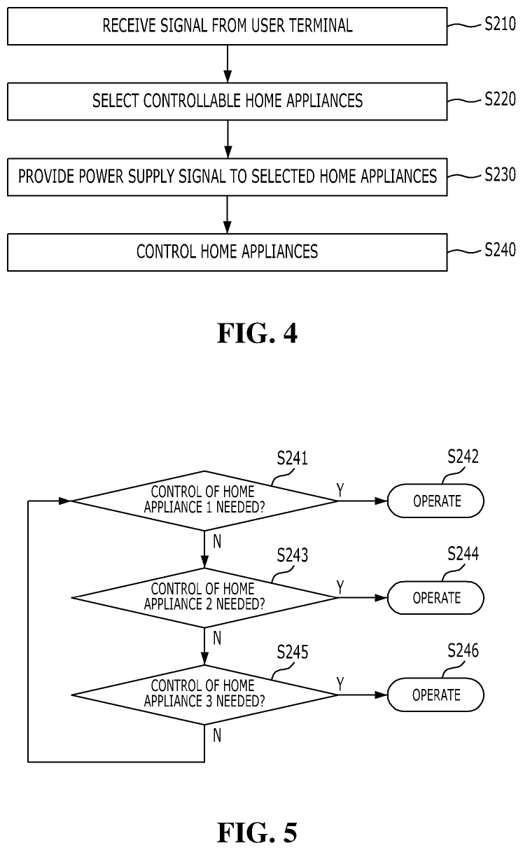

FIG. 3 is a block diagram showing a home appliance control system according to a second embodiment and FIGS. 4 and 5 are flowcharts showing the operation of a non-contact communication module of the home appliance control system according to the second embodiment.

Referring to FIG. 3, a home appliance control system 1000 according to a second embodiment may include a non-contact communication module 500.

The non-contact communication module 500 can perform wireless communication between a home appliance 100 and a server 200 or the home appliance 100 and a user terminal 300. To this end, the non-contact communication module 500 may include a communicator. The communicator can use one of WiFi, Bluetooth, Zigbee, Z-wave, RF, and IR communication, NFC, or a combination of two or more thereof.

The non-contact communication module 500 may include a first communicator 510 and a second communicator 520. The first communicator 510 can perform wireless communication with a plurality of home appliances 100.

The plurality of home appliances 100 may include a refrigerator, a cooker, a washing machine, a cleaner, a water purifier, a fan cooler/heater, a fan, a warmer, an air conditioner, a humidifier, an air purifier, etc., but is not limited thereto. The home appliance 100 may include a communication module 120 therein that can transmit/receive signals to/from the first communicator 510.

A plurality of first communicators 510 may be provided to be able to perform transmission/reception one to one with the plurality of home appliances 100.

The second communicator 520 can perform communication with the server 200. The second communicator 520 can transmit/receive signals to/from the server 200 in a two-way type. Although the second communicator 520 transmits/receives signals to/from the server 200 in the above description, it may directly transmits/receives signals to/from the user terminal 300.

The non-contact communication module 500 may include an information collector 560. The information collector 560 can collect signals received from the plurality of home appliances 100. The information collector 560 may be divided into a first information collector to an n-th information collector to be able to respectively store information of the plurality of home appliances 100. The information collector 560 may be a memory that stores received signals.

The non-contact communication module 500 may include a controller 530.

The controller 530 can transmit a data signal received from the first communicator 510 to the server 200 through the second communicator 520 or can provide a control signal to the home appliance 100 in response to a signal received from the server 200 to control the home appliance 100.

The controller 530 can transmit a data signal provided from the home appliance 100 to the server 200, and when an instruction signal is received from the user terminal 300, the controller 530 can provide a signal to change the operation of the home appliance in response to the instruction signal.

The non-contact communication module 500 may include a power receiver 540.

The power receiver 540 receives power from an external device in a wireless manner. In this embodiment, it is possible to receive wireless power from the home appliance 100. To this end, a power transmitter 140 may be disposed in the home appliance 100. The non-contact communication module 500 may be formed in a pebble shape herein.

The non-contact communication module 500 may include a chargeable battery 550.

The chargeable battery 550 may include a battery pack that can store electricity therein and a PCB that controls charging/discharging of the chargeable battery 550.

The controller 530 can cut off power, depending on the distance between the non-contact communication module 500 and the home appliance 100. For example, when the non-contact communication module 500 is positioned at a predetermined distance away from the home appliance 100 and transmission/reception of a signal is impossible, the power source for the non-contact communication module 500 can be controlled to be cut off. That is, the controller 530 can use real-time power, use the power of the chargeable battery 550, or completely cut off power source, depending on the distance between the non-contact communication module 500 and the home appliance 100.

The non-contact communication module 500 may include a display 570. The display 570 can display the connection state and the control state of the home appliance 100. Accordingly, a user can know the kind of the home appliance 100 that is in operation now.

The display 570 may include a flash type LED or an LCD that shows the connection state and the control state of the home appliance 100 using characters or pictures.

The non-contact communication module 500 may include a sensor 580. The sensor 580 collects surrounding information. The surrounding information may be temperature, humidity, brightness, etc.

Meanwhile, the controller 530 can operate the home appliances 100 to correspond to signals required by a user. For example, when a user requests a pleasant environment, the controller 530 can operate the plurality of home appliances 100 to regulate temperature and humidity measured by the sensor 580 to appropriate levels. The controller 530 can correspond to requests from a user by simultaneously or complexly operate a fan cooler/heater, a humidifier, and an air purifier to correspond to the requests from the user.

Hereafter, the operation of the controller 530 is described with reference to FIGS. 4 and 5.

As shown in FIG. 4, the controller 530 can perform a process of receiving a signal from the user terminal 300 (S210). When a signal is transmitted from the user terminal 300 by a user, the server 200 receives the signal and transmits a signal to the non-contact communication module 500.

When receiving a signal, the controller 530 can perform a process of selecting controllable home appliances 100 (S220). For example, when the received signal is a signal requesting a pleasant environment, the controller 530 can select a fan cooler/heater, a humidifier, and an air purifier from the plurality of home appliances.

The controller 530 can determine whether the controllable home appliances 100 are within an available communication distance and then can select the controllable home appliances 100. For example, when a fan cooler/heater and a humidifier are within an available communication distance, but an air purifier is at an unavailable communication position, the controller 530 can select only the fan cooler/heater and the humidifier.

Further, the controller 530 can determine whether the controllable home appliances 100 are home appliances 100 that are suitable for a request from a user, and then can select the controllable home appliances 100. For example, since temperature and humidity should be considered for a pleasant environment, a water purifier and a cleaner of the home appliances 100 are not included in control targets.

When selecting controllable home appliances 100, the controller 530 can provide a power supply signal to the selected home appliances 100 (S230). The home appliances 100 receive the power supply signal and are powered. In this case, if there is a home appliance without the electric cord connected to a power source, it is possible to inform the controller 530 that power supply is impossible.

The controller 530 controls the home appliances 100 by operating one or more of the controllable home appliances 100.

The operation of controlling and operating a plurality of home appliances is described hereafter with reference to drawings.

The controller 530 controls the home appliances 100 such that temperature becomes about 25 to 27 degrees and humidity becomes 50 to 60 in response to a signal that requests a pleasant environment from a user. The controller 530 can operate the home appliances 100 on the basis of the temperature and humidify measured by the sensor 580.

As shown in FIG. 5, the controller 530 can perform a process of determining whether there is a need for controlling a home appliance 1 (S241). The home appliance 1 may be a fan cooler/heater for increasing or decreasing temperature. The controller 530 determines whether to operate the fan cooler/heater on the basis of the temperature measured by the sensor 580. When the temperature requested by a user is 25 to 27 degrees and the temperature measured by the sensor 580 is less than 25 degrees or higher than 27 degrees, the controller 530 operates the home appliance 1 (S242).

The display 570 shows the operation of the home appliance 1 by turning on a lamp corresponding to the home appliance 1.

However, the temperature measured by the sensor 580 is in the range of temperature requested by a user, the controller 530 does not operate the home appliance 1.

The controller 530 can perform a process of determining whether it is required to operate a home appliance 2 (S243). The home appliance 2 may be a humidifier for increasing humidity. The controller 530 determines whether to operate the home appliance 2 on the basis of the humidity measured by the sensor 580. When the humidity measured by the sensor 580 does not satisfy the humidity requested by a user, the controller 530 operates the home appliance 2 (S244).

The display 570 shows the operation of the home appliance 2 by turning on a lamp corresponding to the home appliance 2.

However, the humidity measured by the sensor 580 is in the range requested by a user, the controller 530 does not operate the home appliance 2.

The controller 530 can perform a process of determining whether it is required to operate a home appliance 3 (S245). The home appliance 3 may be an air purifier for purifying air. The controller 530 determines whether to operate the air purifier on the basis of the degree of air purity measured by the sensor 580. When the degree of air purity measured by the sensor 580 does not satisfy the condition requested by a user, the controller 530 operates the home appliance 3 (S246).

The display 370 shows the operation of the home appliance 3 by turning on a lamp corresponding to the home appliance 3.

However, when the degree of air purity measured by the sensor 580 is in the range requested by a user, the controller 530 does not operate the home appliance 3.

The home appliance control system according to the second embodiment has an effect that it is possible to maintain a pleasant space corresponding to a request from a user by controlling home appliances through wireless communication.

1. A non-contact communication module for a home appliance, the non-contact communication module comprising:
a first communicator transmitting and receiving signals to and from a home appliance through local area wireless communication;
a second communicator transmitting and receiving signals to and from a server or a user terminal; and
a controller transmitting signals received from the first communicator to the user terminal through the second communicator.

2. The non-contact communication module of claim 1, comprising a power receiver that receives power from an external device.

3. The non-contact communication module of claim 2, wherein the external device includes a home appliance, and the home appliance includes a power transmitter therein that transmits power.

4. The non-contact communication module of claim 3, comprising a chargeable battery that is charged with the power received from the power receiver.

5. The non-contact communication module of claim 4, wherein the local area wireless communication includes NFC (near field communication).

6. The non-contact communication module of claim 5, wherein when a distance from the home appliance is less than a first critical value, the controller receives in real time and maintains power, and the first critical value is a distance within which power can be received in real time.

7. The non-contact communication module of claim 6, wherein when the distance from the home appliance is the first critical value or more and less than a second critical value, the controller maintains power using the chargeable battery.

8. The non-contact communication module of claim 7, wherein when the distance from the home appliance is the second critical value or more, power source is cut off, and the second critical value is a distance where a communication signal is disconnected.

9. The non-contact communication module of claim 1, wherein the home appliance includes a plurality of home appliances, and
when a request signal is received from the server or the user terminal, the controller selects controllable home appliances corresponding to the request signal and controls the selected home appliances.

10. A home appliance control system comprising:
a plurality of home appliances each including a communication module;
a server transmitting and receiving signals to and from a server or a user terminal; and
a non-contact communication module transmitting and receiving signals to and from the plurality of home appliances, and transmitting the transmitted and received signals to the server,
wherein the non-contact communication module includes:
a first communicator transmitting and receiving signals to and from the communication module;
a second communicator transmitting and receiving signals to and from the server;
an information collector collecting signals received from the plurality of home appliances; and
a controller analyzing signals collected by the information collector and controlling operation of the home appliances in response to signals provided from the server or the user terminal.

11. The home appliance control system of claim 10, wherein when a request signal is received from the server or the user terminal, the controller selects controllable home appliances corresponding to the request signal and controls the selected home appliances.

12. The home appliance control system of claim 11, wherein the controller determines whether the controllable home appliances are within an available communication distance, and selects the controllable home appliances.

13. The home appliance control system of claim 11, wherein the controller determines whether the controllable home appliances are home appliances that are suitable for a request signal from a user, and selects the controllable home appliances.

14. The home appliance control system of claim 11, wherein the controller provides a power supply signal to the selected home appliances.

15. The home appliance control system of claim 11, wherein the controller operates one or more of the selected home appliances.

16. The home appliance control system of claim 15, wherein the non-contact communication module includes a display that displays a connection state and a control state of the home appliances.

17. The home appliance control system of claim 16, wherein the display includes a flash type LED or an LCD that shows the connection state and the control state of the home appliances using characters.

18. The home appliance control system of claim 10, wherein the non-contact communication module includes a sensor.

19. The home appliance control system of claim 10, wherein the non-contact communication module includes a power receiver that receives power from the home appliances.

20. The home appliance control system of claim 19, wherein the non-contact communication module includes a chargeable battery that is charged with the power received from the power receiver.
